(19) United States
(12) Patent Application Publication
(10) Pub. No.: US 2026/0361903 A1
(43) Pub. Date: Nov. 12, 2026

(54) RELIABLE AND ADAPTIVE VIDEO TRANSMISSION UTILIZING IMPROVED SYNCHRONIZATION, SELECTIVE RETRANSMISSION OF MISSING PACKETS, AND REDUCED PEAK-TO-AVERAGE RATIO OF FRAME BITRATE

(71) Applicant: AMIMON LTD., Ra'anana (IL)

(72) Inventor: Zvi Reznic, Tel Aviv (IL)

(21) Appl. No.: 19/515,502

(22) PCT Filed: Aug. 26, 2024
(86) PCT No.: PCT/IL2024/050856

§ 371 Date: Mar. 2, 2026

Related U.S. Application Data
(60) Provisional application No. 63/579,143, filed on Aug. 28, 2023.

(51) Int. Cl. H04N 19/44; H04L 43/087; H04N 19/115; H04N 19/164; H04N 19/172; H04N 19/196; H04N 19/89

(52) U.S. Cl. CPC H04N 19/44; H04L 43/087; H04N 19/115; H04N 19/164; H04N 19/172; H04N 19/198; H04N 19/89

(57) ABSTRACT

Video is encoded and transmitted from a transmitting device to a recipient device. The recipient device estimates a Communication Network Jitter Level that dynamically quantifies how jittery is the communication network; and it receives only M out of N packets of a particular video frame; N is greater than M; wherein N packets are packetized and transmitted for that particular video frame. The recipient device selectively and dynamically determines, based on the Communication Network Jitter Level, whether (i) to wait for arrival of more packets of not-yet-arrived N-M packets of that video frame, or conversely, (ii) to not wait for arrival of additional packets of that video frame and to immediately perform decoding and rendering of that video frame. The recipient device also selectively determines whether or not to send a retransmission request with regard to a particular missing packet. The transmitting device adjusts configurational parameters of its video encoder, to reduce a Peak-to-Average Ratio (PAR) of the required bitrate.

### CROSS-REFERENCE TO RELATED APPLICATIONS

This patent application claims benefit and priority from U.S. 63/579,143, filed on Aug. 28, 2023, which is hereby incorporated by reference in its entirety.

### FIELD

The present invention relates to the field of communication systems.

### BACKGROUND

Electronic devices and computing devices are utilized on a daily basis by millions of users worldwide. For example, laptop computers, desktop computers, smartphone, tablets, and other electronic devices are utilized for browsing the Internet, consuming digital content, streaming audio and video, sending and receiving electronic mail (email) messages, Instant Messaging (IM), video conferences, playing games, or the like.

Many electronic devices communicate with each other, or with remote servers or remote entities, via one or more wireless communication links or networks; for example, using Wi-Fi, using cellular communications, over the Internet, or the like. Some electronic devices are utilized to receive wireless communications signals that carry video data, to allow such electronic devices to play a streaming video or a video clip on a display unit thereof.

### SUMMARY

Some embodiments provide systems, devices, and methods for reliable and adaptive video transport, particularly over wireless communication network(s) and/or wireless communication link(s).

For example, a transmitting device may transmit packets of video frames towards a recipient device. The recipient device may determine, dynamically and on an ad-hoc basis, whether (I) to continue waiting for one or more not-yet-arrived packet(s) of a current video frame in order to decode and render a particular video frame, or conversely, (II) to stop waiting for the not-yet-arrived packet(s) of that video frame and instead to immediately decode and render that video frame using the already-arrived packets of that video frame.

The dynamic, selective, ad hoc determination is performed, for example, based on the estimated or measured level of network jitter or communication jitter of the communication channel or communication link; namely, the level of variance in the delay of packet arrival at the recipient device from that transmitting device; or based on an estimation at the recipient device of how jittery or non-jittery is the communication channel, relative to a threshold value of network jitter; or based on a communication jitter related characteristic that is estimated or measured by the recipient device. The decision is performed on a per-frame basis, based on recent network jitter estimations.

Additionally or alternatively, some embodiments may selectively and ad hoc determine, in a dynamic and selective manner, whether or not to request (at the recipient device) retransmission of one or more missing/lost/erroneous packets. The ad hoc decision is performed on a per-frame basis. The decision may be performed, for example, based on (or by taking into account): the importance of the missing packet(s) for the decoding of the current video frame; the level of network jitter; the time that already elapsed in waiting for retransmission(s) for this frame or for other frames; and/or other data.

Additionally or alternatively, some embodiments may iteratively or continuously or periodically or repeatedly or gradually modify/adjust the values of encoding parameters or operational settings or coefficients of a Video Encoder, in order to enable a video transmission that causes the recipient device to have a low Peak-to-Average Ratio (PAR) of bitrate per frame; such as, less than 2.0 or less than 1.50 or less than 1.25 PAR of bitrate per frame.

In some embodiments, video is encoded and transmitted from a transmitting device to a recipient device. The recipient device estimates a Communication Network Jitter Level that dynamically quantifies how jittery is the communication network; and it receives only M out of N packets of a particular video frame; N is greater than M; wherein N packets are packetized and transmitted for that particular video frame. The recipient device selectively and dynamically determines, based on the Communication Network Jitter Level, whether (i) to wait for arrival of more packets of not-yet-arrived N-M packets of that video frame, or conversely, (ii) to not wait for arrival of additional packets of that video frame and to immediately perform decoding and rendering of that video frame. The recipient device also selectively determines whether or not to send a retransmission request with regard to a particular missing packet. The transmitting device adjusts configurational parameters of its video encoder, to reduce a Peak-to-Average Ratio (PAR) of the required bitrate.

Some embodiments may provide other and/or additional advantages and/or benefits.

### BRIEF DESCRIPTION OF THE DRAWINGS

FIG. 1 is a schematic illustration of a system, in accordance with some demonstrative embodiments of the present invention.

FIG. 2A is a schematic illustration of a chart demonstrating a high Peak-to-Average Ratio (PAR) value of bitrate per video frame, in an implementation that does not utilize the PAR-reduction scheme of the present invention.

FIG. 2B is a schematic illustration of a chart demonstrating a low Peak-to-Average Ratio (PAR) value of bitrate per video frame, in an implementation that utilizes the PAR-reduction scheme of the present invention.

### DETAILED DESCRIPTION OF SOME DEMONSTRATIVE EMBODIMENTS

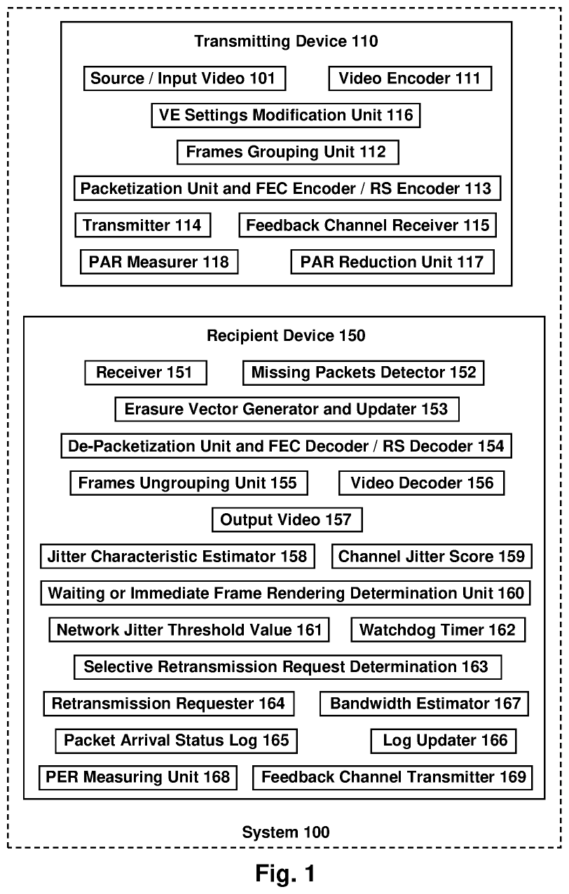

Reference is made to FIG. 1, which is a schematic block-diagram illustration of a system 100, in accordance with some demonstrative embodiments. System 100 comprises a Transmitting Device 110 able to communicate with a Recipient Device 150 over a wireless communication link, and particularly over an Internet Protocol based (IP-based) communication link or over a User Datagram Protocol/Internet Protocol (UDP/IP) communication link.

Transmitting Device 110 stores or receives, or has access to, a Source Video or Input Video 101, which is intended to be transmitted and delivered to the Recipient Device 150. For example, the source/input video may be a pre-recorded or pre-stored video or audio/video file; or may be a live or generally-live video feed from a local or nearby or co-located camera or imager or video acquisition device; or may be a video feed or video stream that the Transmitting Device 110 obtains or downloads or receives from another device or from a remote server, prior to transmitting that video to the Recipient Device 150 and/or during (in parallel to) transmission of that video to the Recipient Device 150. In some embodiments, optionally, the source/input video may be a video that was generated, locally or remotely, in whole or in part, by a Generative Artificial Intelligence (Gen-AI) unit or system, such as based on a prompt or commands or using other methods.

In some embodiments, Transmitting Device 110 comprises a Video Encoder 111 which performs video encoding (or re-encoding, or trans-coding) of the source/input video, for example, using HEVC or H.265 or H.264-SVC or H.264 or AVC or other suitable video compression or encoding standard. Optionally, a Frames Grouping Unit 112 may perform grouping of frames, such that each group of frames utilizes the same single Forward Error Correction (FEC) word or FEC code or Reed-Solomon (RS) word. A Packetization Unit and FEC Encoder/RS Encoder 113 handles the packetization of the encoded frame data and the addition of the FEC codes or RS words. A Transmitter 114 transmits the packets to the Recipient Device 150.

At the Recipient Device 150, a Receiver 151 receives the incoming packets; not necessarily all the transmitted packets are actually received at the Receiver 151. Accordingly, a Missing Packets Detector 152 operates to keep track of the arriving packets and to detect missing packets based on packet serial numbers; optionally utilizing an Erasure Vector Generator and Updater 153 which utilizes a vector representing consecutive packets, such that a value of 1 indicates a missing packet, and a value of 0 indicates a received packet. Then, a De-Packetization Unit and FEC Decoder/RS Decoder 154 operates to de-packetize the data and to perform FEC or RS decoding on the packets that did arrive. Optionally, the FEC/RS decoder may be configured to take advantage of the erasure indication; for example, some RS decoders can correct up to floor(N-K)/2) errors when they do not receive erasure indication, but can correct up to (N-K) errors if they are given erasure indications regarding the location of these errors. A Frames Ungrouping Unit 155 may ungroup a group-of-frames into discrete frames, and a Video Decoder 156 performs decoding (e.g., HEVC or H.265 or H.264-SVC or H.264 or AVC decoding) of each video frame, thereby producing an Output Video 157 which may be outputted or displayed to a user via a screen or monitor or other display unit, and/or which may be further relayed or otherwise displayed to other recipient(s).

Some embodiments utilize improved video synchronization between the transmitting device and the recipient device. For example, the recipient device is configured to estimate or measure or calculate the video timing of the transmitter, along with the network jitter and the jitter characteristics (e.g., average jitter, median jitter, Root Mean Square (RMS) of jitter, Standard Deviation (SD) of jitter, variance of jitter, or other jitter characteristic/s). At the recipient device, a Jitter Characteristic Estimator 158 is configured to estimate or measure such jitter characteristic; and may generate, for example, a Channel Jitter Score 159 indicating how jittery is the communication channel (or the transmission, or the rejection); such as, pertaining to the most-recent T seconds (e.g., the last 10 or 30 or 45 seconds), or pertaining to the most-recent P packets or F frames (e.g., the last 5 or 16 or 32 packets or frames). For example, the generated Jitter Score may be in a scale of 0 to 100, wherein 100 indicates a highly jittery communication channel (or transmission, or reception), and wherein 0 indicates no jitter or minimal jitter that does not adversely affect the video transmission/reception. In other implementations, the network jitter score may be represented in milliseconds, or in other suitable units; and/or may be expressed in absolute units (e.g., average network jitter of 74 milliseconds over the past 10 seconds or over the most-recent 300 video frames), or may be normalized or expressed in relative terms or on a scale or as a percentage point. In some embodiments, the measured or most-recent or calculated or average Network Jitter value, or a characteristic thereof (such as, its mean value for the past T seconds or for the past N frames, or its median value, or its maximum value, the like), may be categorized into one of several pre-defined ranges or Jitter Level Bins; for example, Jitter Level Bin 0=no network jitter at all, Jitter Level Bin 1=network jitter of 1 to 10 milliseconds, Jitter Level Bin 2=network jitter of 11 to 20 milliseconds, Jitter Level Bin 3=network jitter of 21 to 30 milliseconds, Jitter Level Bin 4=network jitter of 31 to 40 milliseconds, and Jitter Level Bin 5=network jitter greater than 40 milliseconds. Other schemes may be used to represent or to indicated the Network Jitter or its characteristic(s).

The value of the Channel Jitter Score, as estimated or measured at the recipient device, enables the recipient device to reach improved decision and to dynamically decide on: whether (I) to continue waiting for a not-yet-arrived packet of a particular video frame, and to not yet commence to decode the video frame based on the already-arrived packet(s) of that video frame, or conversely, (II) to stop waiting or to give-up on waiting for additional or missing packet(s) of that particular video fame, and to immediately perform decoding of that video frame based on the already-arrived packet(s) of that video frame and without waiting (or without further waiting, if a waiting period was already waited) for missing packet(s) of that video frame.

In some embodiments, the Channel Jitter Score may be used for one or more other and/or additional decisions or determinations at the recipient device, and/or may trigger one or more other and/or additional operations at the recipient device; such as, (i) as described above, whether to wait for additional packet(s) to arrive or conversely to decode and render the current frame without the lost packet(s) or without the not-yet-arrived packet(s); and/or (ii) whether or not to request retransmission of a particular packet that did not arrive, as a request for retransmission can be avoided or skipped if the recipient device has already determined to not wait any longer for missing/lost packet(s) and to immediately decode and render the video frame based on the already-arrived packets thereof.

For example, a Waiting or Immediate Frame Rendering Determination Unit 160 may reach, dynamically and ad hoc, the decision of whether to wait for missing/lost/additional packets to arrive in order to decode and render the frame, or conversely, to avoid waiting and/or to give-up on a waiting that was already waited and to immediately decode and render the frame based on the packets that already arrived. For example, if the Channel Jitter Score is greater than a pre-defined Jitter Threshold Value 161, such as 60 in a scale of 0 to 100, then the decision is to give-on on waiting and to immediately decode and render the frame; whereas, if the Channel Jitter Score is equal to or smaller than that pre-defined Jitter Threshold Value 161, the decision is to wait or to continue waiting for the missing packet(s) of that frame, and to postpone or to not-yet-commence decoding or rendering of that frame.

Optionally, the Waiting or Immediate Frame Rendering Determination Unit 160 may include, or may operate in conjunction with, a Watchdog Timer 162 to ensure and to enforce that the waiting period for one or more missing packet(s) does not continue indefinitely, and does not continue more than a pre-defined maximum value of waiting period (e.g., T milliseconds). For example, if T or more milliseconds have passed since a particular milestone was reached (e.g., since the reception of the first-to-arrive packet of this frame; or, in other implementations, since the reception of the last-to-arrive packet of this frame), then the waiting for missing packet(s) is stopped and the Waiting or Immediate Frame Rendering Determination Unit 160 determines to immediately decode and render this frame based on the already-arrived packet(s) and without any further waiting.

In some embodiments, the above-mentioned decision (to wait for arrival of a missing packet, or to decode-and-render the frame immediately) is achieved “ad hoc” or dynamically, on a frame-by-frame basis or on a per-frame basis, such that a decision on Frame 5 does not necessarily affect the decision that would be reached on Frame 6 and does not necessarily result from the decision that was reached on Frame 4. For example, in Frame number 17, if packets 1-6 and 8-9 arrived, the recipient device may decide to wait “0.7 more milliseconds” for the possible arrival of packet 7 before giving up and starting to decode Frame 17; whereas, a minute later, in Frame number 222, if packets 1-6 and 8-9 arrived, the recipient device may decide to wait “0.3 more milliseconds” for the possible arrival of packet 7 before giving up and starting to decode Frame 222; and whereas, two minutes later, in Frame number 555, if packets 1-6 and 8-9 arrived, the recipient device may decide to not wait at all for the possible arrival of packet 7 and to immediately give up and start to decode and render Frame 555; as the decision for each frame is based on (or, takes into account) the current Network Jitter Level, which may change from minute to minute or sometimes at shorter time intervals.

In some embodiments, the exact Timing of requesting (or performing) packet retransmission is also decided/determined based on the jittery/non-jittery behavior exhibited by the communication network/channel, or based on a characteristic of the Network Jitter.

For example, a Selective Retransmission Request Determination Unit 163 may reach, dynamically and ad hoc, the decision of whether or not to request retransmission of one or more missing/lost/not-yet-arrived packets; by taking into account, or based on, the Channel Jitter Score that is estimated or measured at the recipient device, and in coordination with (or, based on) the current or the most-recent decision by the Waiting or Immediate Frame Rendering Determination Unit 160. For example, if the Waiting or Immediate Frame Rendering Determination Unit 160 has just determined to wait or to continue waiting for a particular not-yet-arrived packet, then the Selective Retransmission Request Determination Unit 163 triggers a Retransmission Requester Unit 164 to immediately send (transmit), from the recipient device 150 to the transmitting device 110, a request for retransmission (a retransmission request) pertaining to that missing or not-yet-arrived packet. In contrast, if the Waiting or Immediate Frame Rendering Determination Unit 160 has determined not to continue waiting for a particular not-yet-arrived packet, then the Selective Retransmission Request Determination Unit 163 avoids triggering a retransmission request (or, avoids triggering additional retransmission requests for any not-yet-arrived packets of this frame).

Some embodiments may thus utilize Selective Retransmission of missing/lost packets, such that not every packet that was lost/is missing at the recipient device, is subject to a retransmission request (from the recipient device) or is subject to a retransmission operation (at the transmitting device); or, Selective Sending of Retransmission Requests that the recipient device requests from the transmitting device, such that not every packet that the recipient device determines to be missing/lost (e.g., based on a gap in generally-consecutive packet serial numbers) is subject to a retransmission request.

For example, the recipient device received packets 1, 2, 4, 5, 6, 8, 9. In this example, two packets were lost on the way: packet 3, and packet 7. The recipient device decides selectively, in a selective manner, which packet(s) to request to be retransmitted, and which packets to “let go” and not request them to be retransmitted. The ad hoc decision is made at the recipient device by taking into account the Network Jitter Level, and/or based on whether or not the missing packet is crucial/important/essential for decoding the video frame; or whether or not the information in the missing packet can be completed (entirely or partially) by using redundancy data/FEC data/RS data/error protection data.

For example, in the above-mentioned example, the recipient side may selectively request that packet 3 would be retransmitted (because packet 3 is crucial for decoding the video frame), and will not request that packet 7 would be retransmitted (because packet 7 is not crucial for decoding the video frame, and/or because the content of packet 7 can be completed, partially or entirely, by using FEC/RS data or other redundancy data/error protection data); and once packet 3 is retransmitted and actually arrives to the receiving device, the receiving device will proceed to decode the video frame based on packets 1-6 and 8-9, without packet 7. In some embodiments, additionally, if packet 3 does not arrive within a particular time-slot, the recipient device may determine—optionally by taking into account the Network Jitter Level (which may be greater than a pre-defined threshold)—to “give up” on the waiting for the arrival of missing packet 3, and to decode and render that frame based on the partial data that arrived (packets 1-2 and 4-6 and 8-9), if such decoding is possible. It is noted that in some scenarios, it may be possible to decode the frame without the missing packet 3 (which was regarded as crucial/essential for decoding), since in the meanwhile, packet 7 has arrived to the recipient device and the frame can now be decoded without actually receiving the missing packet 3 and without waiting further for packet 3.

Some embodiments may thus provide a dynamic re-evaluation mechanism that dynamically re-evaluates, possibly on a high-granularity level (e.g., every 1 or 5 or 10 milliseconds), whether or not to continue waiting for missing packet(s) of a given frame or conversely to immediately decode and render that frame without waiting for further packets; and/or, whether to send a retransmission request with regard to one, or some, or all, of the missing packets of a given frame. Optionally, the “Decode Now or Wait for Missing Packet(s)” decision can be re-evaluated and made, dynamically, every T milliseconds, or upon a triggering event (e.g., upon arrival of a missing packet that belongs to this frame), or after T milliseconds elapsed from the reception of the most-recent packet of that frame, or based on one or more other conditions or criteria.

In some embodiments, optionally, a Packet Arrival Status Log 165 may be managed and dynamically updated by a Packet Arrival Status Log Updater 166, and its content can be used by the Waiting or Immediate Frame Rendering Determination Unit 160 and/or by the Selective Retransmission Request Determination Unit 163 to reach decisions. For example, the Packet Arrival Status Log may indicate: that Packet 1 of Frame 47 has arrived (value=0); that Packet 2 of Frame 47 has not arrived (value=1); that Packet 2 of Frame 47 has not arrived and a retransmission request was sent out for it (value=2); and/or other or additional data. In some embodiments, optionally, the Packet Arrival Status Log may further indicate the number of retransmission requests that were sent for a particular packet; the time-stamp or time-point of sending each retransmission request; and/or other data that can be used for decision making by the Waiting or Immediate Frame Rendering Determination Unit 160 and/or by the Selective Retransmission Request Determination Unit 163.

Some embodiments may thus utilize selective and ad-hoc decision making, at the recipient device, on the question of whether (i) to continue waiting for one or more incoming packet(s) before decoding a particular (current) video frame, or (ii) to give up right now on the arrival of additional packet(s) for the current video frame and start right now to decode and render this video frame based on the packets that already arrived and without waiting for additional packet(s) of this video frame that did not yet arrive. The decision is based how Jittery is the communication channel/network with regard to packet arrival.

As a first example, the recipient device received packets 1, 2, 3, 4, 5, 6, 8, 9. It observes that Packet 7 is missing; Packet 7 did not arrive. The recipient device sent back (to the transmitting device) a request for retransmission of missing packet 7. The recipient device decides, on an ad hoc basis, as time goes by, in a dynamic manner, about the Timing of “giving up” on the waiting for the missing packet: whether (I) to “give up” on the arrival of missing packet 7 and to stop waiting and to immediately decode and render the video frame based on packets 1-6 and 8-9, or alternatively, (II) to continue waiting for missing packet 7 to arrive.

A factor in the decision-making process at the recipient device is the estimated/measured/known level of Jitter in (or of) the transmission channel or the communication channel. If the transmission channel has recently exhibited (e.g., in the most-recent T seconds, such as in the most recent 10 seconds) a Highly Jittery behavior (e.g., some packets arrive immediately, and some packets arrive at a great delay that is greater than D milliseconds), then this information supports a decision to Wait a more time for the missing packet 7 to arrive before decoding this frame. In contrast, if the transmission channel has recently exhibited a Non-Jittery or a Low-Jitter behavior (e.g., all or most of the packets arrived immediately, with few or no missing packets/delayed packets), then this information supports a decision to Not Wait any more for the missing packet 7 to arrive, and instead to proceed immediately to decoding and rendering the video frame without packet 7.

In accordance with some embodiments, the Communication Channel Jitter or the Communication Network Jitter indicates, or is, the unwanted or undesired or too large of a variation in the time delay between when a signal (or packet) is transmitted and when that signal (or packet) is received over a network connection. In other words, a network jitter is a variance in latency between packets sent over the network. The jitter level may indicate the level of disruption in the sequence of arriving (or leaving) packets from the transmitting device. The measured or estimated network jitter or communication channel jitter may be of various types, such as: Constant Jitter, indicating a roughly constant level of packet delay variation; Transient Jitter, indicating a substantial delay of a single packet; Short-Term Jitter, indicating a substantial delay of some number of packets; or a combination or mixture or two or more types of jitter over time.

The network jitter or the communication channel jitter, or the packet timing arrival delay jitter, may be measured or estimated using one or more suitable ways; For example, by using the round-trip time (RTT) of a series of packets originating from the same transmitting device 110; by measuring the variation between transmission times between two endpoints in the network; by estimating or measuring the bandwidth of the network/communication link, which may assist in estimating the jitter level; by using ping operations, which take the differences between two consecutive packet travel times and calculates their mean value to get the average jitter in the network; and/or by otherwise measuring or estimating the average of the absolute differences between the expected and actual arrival times of packets, usually measured in milliseconds.

For the purpose of estimating, detecting, and/or measuring of the Jitter level of the communication channel, some embodiments may optionally utilize one or more units or methods described, for example, in one or more of the following publications that are hereby incorporated by reference in their entirety: in patent U.S. Pat. No. 8,537,951 B2, titled “Detection of jitter in a communication network”; and/or in South Korean patent application publication number KR 10-2013-0009670 A, titled “Packet transmission apparatus and method, and packet reception apparatus and method in MMT system”; and/or other suitable ways.

Additionally or alternatively, with regard to transmission and/or reception of video, and/or with regard to encoding and/or decoding of video, some embodiments may utilize one or more units or methods described, for example, in one or more of the following publications that are hereby incorporated by reference in their entirety: in patent U.S. Pat. No. 11,490,140, titled “System, device, and method for robust video transmission utilizing user datagram protocol (UDP)”; and/or in patent application publication number US 2022/0060767 A1, titled “System, device, and method for robust video transmission utilizing User Datagram Protocol (UDP)”.

In some embodiments, the communication protocol between the transmitting device and the recipient device may further be configured to dynamically modify or adjust the values or coefficient or the working point of one or more mechanisms or parameters of the FEC/RS encoder and/or the Video Encoder (e.g., including the modification or the determining of its Constant Bitrate parameter value); by taking into account the estimated/measured bandwidth of the communication channel/link, and/or the Network Jitter Level, and/or the Packet Error Rate (PER) or packet loss rate or other quality indicator or failure indicator. Data about these parameters, or data that is useful for adjusting or modifying or determining these parameters, can be sent in an uplink from the recipient device to the transmitting device, or can be provided in a feedback channel or a control channel from the recipient device to the transmitting device, enabling adaptive video streaming that is immediately adjusted based on momentary or contemporary bandwidth/PER/jitter level of the communication link, and enabling the system to dynamically modify the operational parameters of the CBR video encoder and/or the FEC/RS encoder based on momentary or contemporary changes in bandwidth/PER/jitter level of the communication link.

In some embodiments, the system may provide Fast Recovery from serious network issues, such as a communication outage of 0.5 second or 1 second; as the recipient device may continue rendering the last decodable video frame, and once the network outage is over, the recovery will be fast, based on the last known estimations.

Some embodiments may further utilize, provide, or enforce a low or relatively-low Peak to Average Ratio, which is an enabler for achieving or facilitating low latency. For example, in a communication channel having a generally stable bandwidth that the system would like to fully utilize, a large Peak to Average Ratio will necessitate buffering and would thus increase latency. In some embodiments, the Video Encoder is tuned, or its parameters or coefficients or working point are modified or are set dynamically, to a working point that provides a low Peak to Average Ratio that is below a pre-defined threshold value.

In a demonstrative implementation, the Recipient Device may include: (I) a Bandwidth Estimator 167, configured to continuously or periodically estimate or measure the actual or the effective bandwidth of the communication channel/link between the Transmitting Device and the Recipient Device; and/or (II) a Packet Error Rate (PER) Measuring Unit 168, configured to measure or estimate the PER, such as, by calculating: the number of erroneous packets after FEC, divided by the total number of received packets).

Additionally or alternatively, the Transmitting Device may include a Peak-to-Average Ratio (PAR) Measuring Unit 118, configured to measure the actual PAR of each frame and/or the average PAR value for the most-recent N frames (e.g., for the most-recent 10 or 50 or 300 frames); although in some embodiments, the PAR measuring unit may be located at the Recipient Device, which may periodically send the measured PAR value via an uplink or feedback channel or control channel to the Transmitting Device.

The value of the estimated bandwidth, and/or the value of the measured PER, and/or the value of the most-recent PAR or the average PAR (if calculated at the Recipient Device), and/or the value of the estimated Channel Jitter Score 159, may be sent periodically from a Feedback Channel Transmitter 169 of the Recipient Device 150 to a Feedback Channel Receiver 115 of the Transmitting Device.

Based on the values of the above-mentioned parameters, or some of them or one of them, or all of them, the Transmitting Device may configure or modify or adjust the operational settings or coefficients of its Video Encoder 111. For example, a VE Settings Modification Unit 116 may modify or set or adjust or increase or decrease the value(s) of one or more parameters or coefficients or threshold-values of the Video Encoder, based on the feedback indicating the bandwidth and/or PER and/or PAR and/or Network Jitter.

In some embodiments, the modifications or adjustments of the Video Encoder parameters may be performed iteratively or gradually, such that updated parameter values are received again as new feedback after each gradual/iterative modification of Video Encoder settings, in an attempt to reach or converge towards a high PAR, or towards a PAR that is greater than a pre-defined threshold value, or towards a PAR that is within a particular range of threshold values, in a dynamic and adaptive process. Optionally, such modifications or adjustments of parameter values or encoding coefficients may be managed, controlled, determined and/or performed by a PAR Reduction Unit 117, which may perform an algorithm or a set of rules for gradual/iterative/repeated modification of values until the CBR stabilizes around a desired target, and that may continue to perform such modifications to maintain the CBR within a limited band around that target CBR value (e.g., within 5 or 10 or 20 percent below or above that target CBR value).

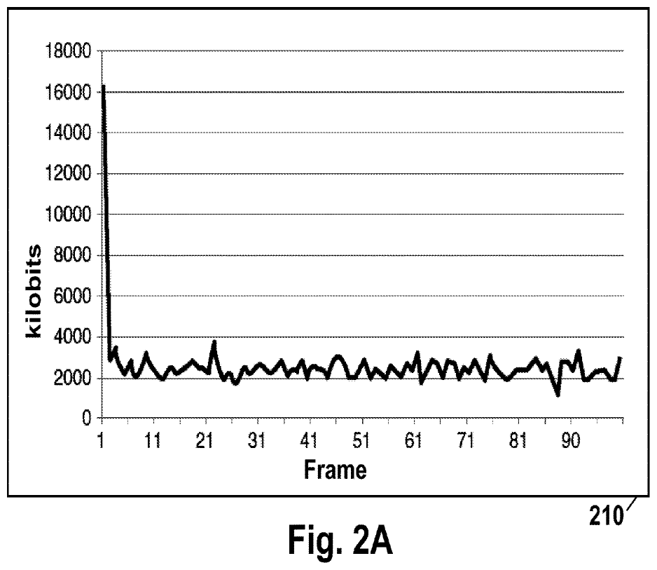

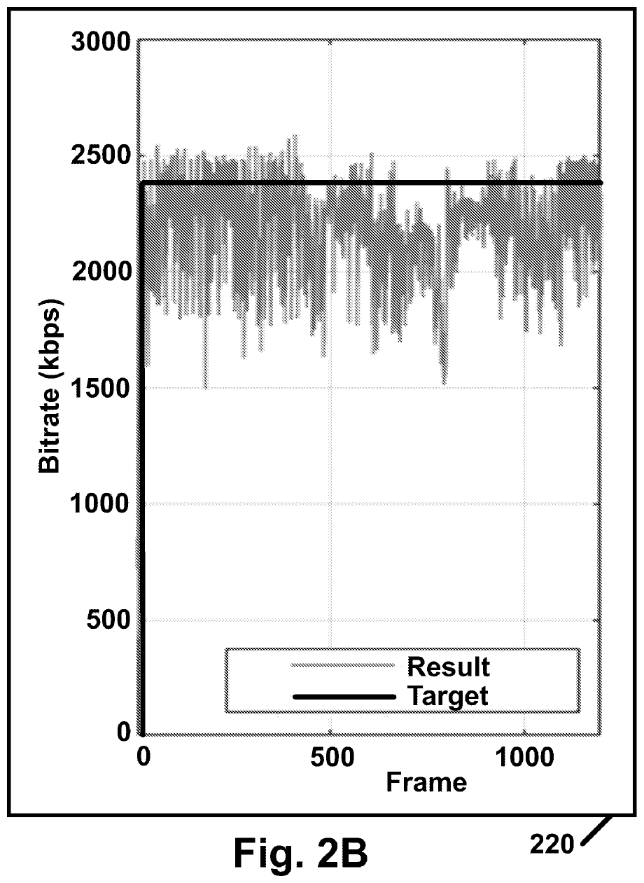

Reference is made to FIG. 2A, which is a schematic illustration of a chart 210, demonstrating a high PAR value, in an implementation that does not utilize the PAR-reduction scheme of the present invention. The horizontal axis indicates the index number of the frames. The vertical axis may indicate kilobits (per frame, or per second), or may indicate the required / the utilized bitrate or bandwidth (e.g., in kbps). It can be observed that the initial frame(s) cause a high peak of required bitrate or bandwidth, before stabling around a generally constant (and lower) bitrate; thus creating a high PAR value, which in turn requires extensive/excessive buffering capabilities. For example, the highest peak of bitrate is over 16,000 kbps; whereas the generally constant bitrate stabilizes at around 3,000 kbps; such that the PAR value is approximately 16/3, or approximately 5.33; or such that the peak bitrate is more than five times the value of the generally-stable CBR or the desired/effective/average CBR.

Reference is made to FIG. 2B, which is a schematic illustration of a chart 220, demonstrating a low PAR value, in an implementation that utilizes the PAR-reduction scheme of the present invention. The horizontal axis indicates the index number of the frames. The vertical axis may indicate the corresponding bitrate (or required bandwidth) in kilobits (e.g., per frame), or may indicate the required/the utilized bitrate or bandwidth (e.g., in kbps). The darker and thicker line, denoted as “Target”, rises immediately at the first frame from zero to a target bitrate, and remains horizontal and linear (indicating a constant bitrate, CBR); it indicates (or may correspond to) a target Constant Bitrate (CBR) around which the actual bitrate is expected or desired to stabilize. The gray line, denoted as “Result”, indicates the actual bitrate used to represent each video frame; it hugs the horizontal Target line, without surpassing it with any high peak(s); it is typically below the horizontal Target line, and it sometimes surpasses the dark horizontal Target line by not more than 10 or 15 or 20 percent (e.g., the CBR target line being 2,400 kbps; the gray Actual Result line reaches, at most, a peak of around 2,640 which is 10 percent more than the CBR of 2,400). The PAR value demonstrated in chart 220 of FIG. 2B is thus around 1.10. Some implementations may similarly achieve a PAR value that is lower than 1.05, or that is lower than 1.10, or that is lower than 1.15, or that is lower than 1.20, or that is lower than 1.25, or that is lower than 1.50, or that is lower than 2.0.

It is also noted that the term CBR or Constant Bitrate, as used herein, is still correct even though the actual/effective bitrate is not mathematically constant at all times and for all frames; rather, the term CBR or Constant Bitrate indicates that the video encoder is configured to encode video frames at a Generally Constant or Generally Similar bitrate per frame, such that the required bitrate per video frame is 5 or 10 or 20 or 25 percent above or below a desired Generally Constant bitrate, and there is not large peak or large dip that are more than 50 percent above or below such desired Generally Constant bitrate.

It is noted that the data demonstrated in chart 220 may correspond to video data of a “coarse” or “base” layer of a video encoding scheme (such as H.265), or to video data of a “fine” or “refinement” layer of a video encoding scheme (such as H.265), or to the combined data of bother the coarse and the refinement video data of such multi-layer/multi-channel video encoding scheme.

It can be observed that the initial frame(s) do not cause a high peak of required bitrate or bandwidth, but rather, the frames are rapidly stabling around a generally constant (and low) bitrate; thus creating a low PAR value, which in turn does not requires extensive / excessive buffering capabilities.

Referring back to FIG. 1, it is clarified that each of the units of system 100 may be implemented by utilizing hardware component(s) and/or software component(s). In some embodiments, units or devices of system 100 may comprise, or may be implemented using, other suitable components such as, for example: a processor, a Central Processing Unit (CPU), a Digital Signal Processor (DSP), a Graphics Processing Unit (GPU), a processing core, a controller, a logic unit, memory units (e.g., Random Access Memory (RAM), Flash memory), storage units (e.g., hard disk drive, solid state drive, optical drive), an input unit (e.g., keyboard, keypad, mouse, trackball, audio microphone, touch-screen), an output unit (e.g., screen, touch-screen, audio speakers), a power source (e.g., battery, power cell, connection to mains electric power), one or more wired and/or wireless transceivers (e.g., Wi-Fi transceiver, Bluetooth transceiver, cellular transceiver), a housing that holds together some or all of the components of the device, an Operating System (OS) with drivers and applications, and/or other suitable hardware components and/or software components.

Some embodiments provide a method of video transmission over an Internet Protocol (IP) communication link, from a transmitting device to a recipient device. For example, the method comprises: (a) at the recipient device, estimating a Communication Network Jitter Level that dynamically quantifies how jittery is the communication network between the transmitting device and the recipient device; (b) at the recipient device, receiving M out of N packets of a particular video frame, wherein N is greater than M, and wherein N packets are being packetized and transmitted (or, were already packetized and transmitted; or, are currently being packetized and/or transmitted, and/or are currently in the process of being packetized at the transmitting device and/or being transmitted by the transmitting device) from the transmitting device as a representation of said particular video frame; (c) at the recipient device, selectively and dynamically determining, based on the Communication Network Jitter Level, whether (c1) to wait for arrival of one or more packets of not-yet-arrived N-M packets of said particular video frame while not yet decoding and rendering said particular video frame, or conversely, (c2) to not wait for arrival of additional packets of said particular video frame and to immediately perform decoding and rendering of said particular video frame.

In some embodiments, the determining of step (c) is performed on a Per Frame basis, and/or on a Frame-By-Frame basis, such that the determining is or can be dynamically different across two or more consecutive frames or non-consecutive frames. For example, in Video Frame number 14, only 6 out of a total of 9 video packets have arrived to the recipient device, and the recipient device decides-based on a high level of communication network jitter (e.g., which is greater than or equal to a pre-defined threshold value)-to not wait any longer for the remaining 3 video packets (or for one or some of them), and to immediately decode and render this video frame based on the 6 already-arrived video packets; whereas, in contrast, in Video Frame number 15 (the consecutive frame) or in Video Frame number 93 (non-consecutive frame), only 8 out of 10 video packets have arrived to the recipient device, and the recipient device may decide to continue waiting for 1 or 2 not-yet-arrived packet(s) out of the two not-yet-arrived packets of that frame, and not yet to decode/render that video frame, taking into account that there is a low level of communication network jitter (e.g., as it is below a pre-defined threshold value).

Additionally or alternatively, in some embodiments, the dynamic and selective decision or determination at the recipient device, is performed on a per-packet basis, or on a packet-by-packet basis, or on a per-video-packet basis, or on a video-packet-by-video-packet basis, within the same video frame; and the determining is re-performed or re-evaluated, as needed, upon the arrival of each additional video packet of that same video frame. For example, in Video Frame 37, the transmitting device encoded and transmitted a total of 9 video packets to represent that frame. Upon receiving 6 out of those 9 video packets, the recipient device performs an evaluation, takes into account that the current level of network jitter buffer is low (e.g., is below a pre-defined threshold value), and determines to continue waiting for additional video packet/s of that video frame 37. After a few milliseconds, a Seventh video packet arrives to the recipient device, for that video frame 37; and upon receiving those 7 out of 9 video packets of that video frame, the recipient device again performs a fresh evaluation, takes into account that the current level of network jitter buffer is still low (e.g., is below a pre-defined threshold value), and determines to continue waiting for additional video packet/s of that video frame 37. After a few more milliseconds, an Eighth video packet arrives to the recipient device, for that video frame 37; and upon receiving those 8 out of 9 video packets of that video frame, the recipient device again performs a fresh evaluation, but this time it takes into account that the current level of network jitter buffer is high (e.g., is equal to or greater than said pre-defined threshold value), and it determines to stop waiting for the remaining additional video packet of that video frame 37, and it determines to immediately decode and render that video frame 37 based on the 8 video packets that arrived.

In some embodiments, said N packets, together, are a full representation of said particular video frame as encoded by said transmitting device; and the method comprises: at the recipient device, determining to not wait for arrival of not-yet-arrived N-M packets (namely, N minus M packets) of said particular video frame, and determining to immediately perform decoding and rendering of said particular video frame, if the Communication Network Jitter Level is greater than a pre-defined threshold value, and without waiting to receive said N packets that are the full representation of said particular video frame.

In some embodiments, step (c) of selectively and dynamically determining, is performed at the recipient device on a frame-by-frame basis; wherein a value of N is different or can be different across two consecutive video frames; wherein a value of M is different or can be different across two consecutive video frames.

In some embodiments, the method comprises: (A) in receiving and decoding a first video frame F1, for which the transmitting device encodes a total of N1 video packets, the recipient device receives only M1 video packets of said total of N1 video packets, and immediately decodes and renders that first video frame F1 upon reception of said M1 video packets, without waiting to receive one or more of not-yet-arrived N1-M1 video packets (namely, N1 minus M1 video packets) of said first frame F1; (B) in receiving and decoding a second video frame F2, for which the transmitting device encodes a total of N2 video packets, the recipient device receives only M2 video packets of said total of N2 video packets, and immediately decodes and renders that second video frame F2 upon reception of said M2 video packets, without waiting to receive one or more of not-yet-arrived N2-M2 video packets (namely, N2 minus M2 video packets) of said second frame F2; wherein N1 is different than M2; wherein M1 is different than M2.

In some embodiments, said N video packets are a full representation of said particular video frame; wherein the value of N differs across different video frames of the same video that is transmitted from the transmitting device to the recipient device.

In some embodiments, the value of N is conveyed or relayed or transmitted, explicitly, from the transmitting device to the recipient device; in each video frame or per each video frame; such as, the value of N can be encoded or stored within a first video packet of the video frame, or within a header or a footer region of one or more of the video packets of that video frame; or, the value of N can be conveyed or transmitted from the transmitting device to the recipient device as part of an additional short-length packet, or as part of a control message that accompanies the video packets of that video frame. In some embodiments, optionally, the recipient device can autonomously or independently estimate the value of N (e.g., the total number of video packets that are estimated to represent a full video frame), without being explicitly provided with the value of N; for example, the recipient device may monitor and may observe that each of the last 90 frames had on average 9 video packets per frame and/or had a median value of 9 video packets per frame, and therefore the recipient device can estimate that N would be 9 also for frame number 91 that is currently being gradually received.

In some embodiments, the determining of step (c) is performed dynamically on a Per Video-Packet Basis, and is performed a plurality of times while the recipient device keeps receiving video packets of said particular video frame; wherein for said particular video frame, the transmitting device encodes a total of N video packets as a full representation of said particular video frame; wherein, upon receiving only M1 video packets out of said total of N video packets, the recipient device determines to continue waiting for not-yet-arrived video packets of said particular video frame; and wherein, conversely, upon receiving only M2 video packets of said total of N video packets, wherein M2 is greater than M1 but wherein M2 is smaller than N, the recipient device determines to stop waiting for not-yet-arrived video packets of said particular video frame and determines to immediately decode and render said particular video frame.

In some embodiments, the determining of step (c) is performed dynamically on a Per Video-Frame Portion Basis, and is performed a plurality of times while the recipient device keeps receiving video packets of said particular video frame; wherein for said particular video frame, the transmitting device encodes a total of N video packets as a full representation of said particular video frame; wherein, upon receiving only a first portion P1 of said total of N video packets, the recipient device determines to continue waiting for not-yet-arrived video packets of said particular video frame; and wherein, conversely, upon receiving only a second portion P2 of said total of N video packets, wherein P2 is greater than P1, the recipient device determines to stop waiting for not-yet-arrived video packets of said particular video frame and determines to immediately decode and render said particular video frame.

In some embodiments, the determining of step (c) comprises: if the Communication Network Jitter Level is greater than a pre-defined network jitter value, then performing step (c2) of immediately decoding and rendering; otherwise, performing step (c1) of waiting for arrival of one or more additional packets of said particular video frame.

In some embodiments, upon performing step (c1) of waiting for arrival of one or more additional packets of said particular video frame, the method further comprises: stopping said waiting, and switching to perform step (c2) of immediately decoding and rendering said particular video frame., if a pre-defined time-period elapsed since arrival of most-recent packet of said particular video frame.

In some embodiments, step (c) of selectively and dynamically determining, is performed on per-frame basis and is based exclusively on (i) the number of packets M that already arrive for said particular video frame, and (ii) a value of the Communication Network Jitter Level as estimated by the recipient device.

In some embodiments, step (c) of selectively and dynamically determining, is performed on per-frame basis and is independent from, and does not rely on, arrival or non-arrival of packets in any video frames that precede said particular video frame.

In some embodiments, step (c) of selectively and dynamically determining, is performed on per-frame basis and is independent from, and does not rely on, arrival or non-arrival of packets in any video frames that follow said particular video frame.

In some embodiments, the selectively and dynamically determining in step (c) is performed on per-frame basis and is independent from, and does not rely on, an importance for decoding purposes of a payload that is carried by not-yet-arrived N-M packets of said particular video frame.

In some embodiments, the method further comprises: (d) at the recipient device, selectively and dynamically determining, on a per-frame basis, and by taking into account the Communication Network Jitter Level, whether (d1) to send from the recipient device to the transmitting device a Retransmission Request for a missing packet of said particular video frame, or conversely, (d2) to skip sending from the recipient device to the transmitting device a Retransmission Request for said missing packet of said particular video frame.

In some embodiments, the method further comprises: (d) at the recipient device, selectively and dynamically determining, on a per-frame basis (or on a frame-by-frame basis) and also on a per-packet basis (or on a packet-by-packet basis), whether (d1) to send from the recipient device to the transmitting device a Retransmission Request for a missing packet of said particular video frame, or conversely, (d2) to skip sending from the recipient device to the transmitting device a Retransmission Request for said missing packet of said particular video frame; wherein the step of selectively and dynamically determining, on a per-frame basis and also on a per-packet basis, comprises: (I) for said particular video frame, selectively sending from the recipient device a first Retransmission Request to request retransmission of a first particular packet of said particular video frame, and also, (II) for same said particular video frame, selectively skipping to send from the recipient device a second Retransmission Request with regard to a second, different, particular packet of said particular video frame.

In some embodiments, the method comprises: selectively and dynamically determining, on a per-frame basis and also on a per-packet basis, whether or not to send a Retransmission Request for a particular missing packet of said video frame, is based on: an estimation at the recipient device with regard to the importance of said particular missing frame for successful decoding of said particular video frame.

In some embodiments, the method further comprises: (d1) measuring bitrate of video frames that are generated via a Constant Bitrate (CBR) video encoding scheme by a video encoder of the transmitting device; (d2) determining a highest peak of said bitrate of video frames; (d3) determining a generally-constant bitrate value of said video frames; (d4) determining a Peak-to-Average Ratio (PAR) value of said video frames, by dividing said highest peak by said generally-constant bitrate value; (e) at the transmitting device, dynamically modifying an operational setting of the video encoder of said transmitting device, to reduce said bitrate PAR value. In some embodiments, the method comprises: iteratively performing step (e) by applying gradual modifications to said operational setting of the video encoder, until convergence towards a target PAR value.

In some embodiments, the method comprises: iteratively performing step (e) until said PAR value is lower than 2 (or, is lower than 1.75; or, is lower than 1.5; or, is lower than 1.33; or, is lower than 1.25). In some embodiments, said method is performed not necessarily with regard to CBR encoded video, but rather, with regard to Variable Bitrate (VBR) encoded video; wherein the method is configured to iteratively configure and re-configure operational settings of the video encoder, to reduce the bitrate PAR value to be lower than 2 (or, to be lower than 1.75; or, to be lower than 1.5; or, to be lower than 1.33; or, to be lower than 1.25).

In some embodiments, optionally, the method comprises: eliminating, or reducing the size of, a reception buffer or a reception jitter buffer, at the recipient device, that stores or buffers incoming/arriving video packets; based on (or upon) achieving a bitrate PAR value that is smaller than a pre-defined threshold value (e.g., is smaller than 1.5), and/or if the communication network jitter level is below a pre-defined threshold value.

In some embodiments, calculations, operations and/or determinations may be performed locally within a single device, or may be performed by or across multiple devices, or may be performed partially locally and partially remotely (e.g., at a remote server) by optionally utilizing a communication channel to exchange raw data and/or processed data and/or processing results.

Although portions of the discussion herein relate, for demonstrative purposes, to wired links and/or wired communications, some embodiments are not limited in this regard, but rather, may utilize wired communication and/or wireless communication; may include one or more wired and/or wireless links; may utilize one or more components of wired communication and/or wireless communication; and/or may utilize one or more methods or protocols or standards of wireless communication.

Some embodiments may be implemented by using a special-purpose machine or a specific-purpose device that is not a generic computer, or by using a non-generic computer or a non-general computer or machine. Such system or device may utilize or may comprise one or more components or units or modules that are not part of a “generic computer” and that are not part of a “general purpose computer”, for example, cellular transceivers, cellular transmitter, cellular receiver, GPS unit, location-determining unit, accelerometer(s), gyroscope(s), device-orientation detectors or sensors, device-positioning detectors or sensors, or the like.

Some embodiments may be implemented as, or by utilizing, an automated method or automated process, or a machine-implemented method or process, or as a semi-automated or partially-automated method or process, or as a set of steps or operations which may be executed or performed by a computer or machine or system or other device.

Some embodiments may be implemented by using code or program code or machine-readable instructions or machine-readable code, which may be stored on a non-transitory storage medium or non-transitory storage article (e.g., a CD-ROM, a DVD-ROM, a physical memory unit, a physical storage unit), such that the program or code or instructions, when executed by a processor or a machine or a computer, cause such processor or machine or computer to perform a method or process as described herein. Such code or instructions may be or may comprise, for example, one or more of: software, a software module, an application, a program, a subroutine, instructions, an instruction set, computing code, words, values, symbols, strings, variables, source code, compiled code, interpreted code, executable code, static code, dynamic code; including (but not limited to) code or instructions in high-level programming language, low-level programming language, object-oriented programming language, visual programming language, compiled programming language, interpreted programming language, C, C++, C #, Java, JavaScript, SQL, Ruby on Rails, Go, Cobol, Fortran, ActionScript, AJAX, XML, JSON, Lisp, Eiffel, Verilog, Hardware Description Language (HDL, BASIC, Visual BASIC, MATLAB, Dart, Pascal, HTML, HTML5, CSS, Perl, Python, PHP, machine language, machine code, assembly language, or the like.

Discussions herein utilizing terms such as, for example, “processing”, “computing”, “calculating”, “determining”, “establishing”, “analyzing”, “checking”, “detecting”, “measuring”, or the like, may refer to operation(s) and/or process(es) of a processor, a computer, a computing platform, a computing system, or other electronic device or computing device, that may automatically and/or autonomously manipulate and/or transform data represented as physical (e.g., electronic) quantities within registers and/or accumulators and/or memory units and/or storage units into other data or that may perform other suitable operations.

The terms “plurality” and “a plurality”, as used herein, include, for example, “multiple” or “two or more”. For example, “a plurality of items” includes two or more items.

References to “one embodiment”, “an embodiment”, “demonstrative embodiment”, “various embodiments”, “some embodiments”, and/or similar terms, may indicate that the embodiment(s) so described may optionally include a particular feature, structure, or characteristic, but not every embodiment necessarily includes the particular feature, structure, or characteristic. Furthermore, repeated use of the phrase “in one embodiment” does not necessarily refer to the same embodiment, although it may. Similarly, repeated use of the phrase “in some embodiments” does not necessarily refer to the same set or group of embodiments, although it may.

As used herein, and unless otherwise specified, the utilization of ordinal adjectives such as “first”, “second”, “third”, “fourth”, and so forth, to describe an item or an object, merely indicates that different instances of such like items or objects are being referred to; and does not intend to imply as if the items or objects so described must be in a particular given sequence, either temporally, spatially, in ranking, or in any other ordering manner.

Some embodiments may be used in, or in conjunction with, various devices and systems, for example, a Personal Computer (PC), a desktop computer, a mobile computer, a laptop computer, a notebook computer, a tablet computer, a server computer, a handheld computer, a handheld device, a Personal Digital Assistant (PDA) device, a handheld PDA device, a tablet, an on-board device, an off-board device, a hybrid device, a vehicular device, a non-vehicular device, a mobile or portable device, a consumer device, a non-mobile or non-portable device, an appliance, a wireless communication station, a wireless communication device, a wireless Access Point (AP), a wired or wireless router or gateway or switch or hub, a wired or wireless modem, a video device, an audio device, an audio-video (A/V) device, a wired or wireless network, a wireless area network, a Wireless Video Area Network (WVAN), a Local Area Network (LAN), a Wireless LAN (WLAN), a Personal Area Network (PAN), a Wireless PAN (WPAN), or the like.

Some embodiments may be used in conjunction with one way and/or two-way radio communication systems, cellular radio-telephone communication systems, a mobile phone, a cellular telephone, a wireless telephone, a Personal Communication Systems (PCS) device, a PDA or handheld device which incorporates wireless communication capabilities, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like.

Some embodiments may comprise, or may be implemented by using, an “app” or application which may be downloaded or obtained from an “app store” or “applications store”, for free or for a fee, or which may be pre-installed on a computing device or electronic device, or which may be otherwise transported to and/or installed on such computing device or electronic device.

Functions, operations, components and/or features described herein with reference to one or more embodiments of the present invention, may be combined with, or may be utilized in combination with, one or more other functions, operations, components and/or features described herein with reference to one or more other embodiments of the present invention. The present invention may thus comprise any possible or suitable combinations, re-arrangements, assembly, re-assembly, or other utilization of some or all of the modules or functions or components that are described herein, even if they are discussed in different locations or different chapters of the above discussion, or even if they are shown across different drawings or multiple drawings.

While certain features of some demonstrative embodiments of the present invention have been illustrated and described herein, various modifications, substitutions, changes, and equivalents may occur to those skilled in the art. Accordingly, the claims are intended to cover all such modifications, substitutions, changes, and equivalents.

1. A method of video transmission over an Internet Protocol (IP) communication link, from a transmitting device to a recipient device, the method comprising:
(a) at the recipient device, estimating a Communication Network Jitter Level that dynamically quantifies the degree of jitter in the communication network between the transmitting device and the recipient device, wherein the Communication Network Jitter Level indicates a level of variance in delay of packet arrival at the recipient device from the transmitting device;
(b) at the recipient device, receiving M out of N packets of a particular video frame, wherein N is greater than M, and wherein N packets are packetized and transmitted from the transmitting device as a representation of said particular video frame;
(c) at the recipient device, selectively and dynamically determining, based on the Communication Network Jitter Level, whether (c1) to wait for arrival of one or more packets of not-yet-arrived N-M packets of said particular video frame while not yet decoding and rendering said particular video frame, or conversely, (c2) to not wait for arrival of additional packets of said particular video frame and to immediately perform decoding and rendering of said particular video frame; and
(d) at the recipient device, selectively and dynamically determining, on a per-frame basis, and by taking into account the Communication Network Jitter Level, whether (d1) to send from the recipient device to the transmitting device a Retransmission Request for a missing packet of said particular video frame, or conversely, (d2) to skip sending from the recipient device to the transmitting device a Retransmission Request for said missing packet of said particular video frame.

2. The method of claim 1, wherein said N packets, together, are a full representation of said particular video frame as encoded by said transmitting device; wherein the method comprises: at the recipient device, determining to not wait for arrival of not-yet-arrived N-M packets of said particular video frame, and determining to immediately perform decoding and rendering of said particular video frame, if the Communication Network Jitter Level is greater than a pre-defined threshold value, and without waiting to receive said N packets that are the full representation of said particular video frame.

3. The method of claim 1, wherein step (c) of selectively and dynamically determining, is performed at the recipient device on a frame-by-frame basis, wherein a value of N differs across two consecutive video frames, and wherein a value of M differs across said two consecutive video frames.

4. The method of claim 1, comprising: in receiving and decoding a first video frame F1, for which the transmitting device encodes a total of N1 video packets, the recipient device receives only M1 video packets of said total of N1 video packets, and immediately decodes and renders that first video frame F1 upon reception of said M1 video packets, without waiting to receive one or more of not-yet-arrived N1-M1 video packets of said first frame F1; in receiving and decoding a second video frame F2, for which the transmitting device encodes a total of N2 video packets, the recipient device receives only M2 video packets of said total of N2 video packets, and immediately decodes and renders that second video frame F2 upon reception of said M2 video packets, without waiting to receive one or more of not-yet-arrived N2-M2 video packets of said second frame F2; wherein N1 is different than N2; wherein M1 is different than M2.

5. The method of claim 1, wherein said N video packets are a full representation of said particular video frame; wherein the value of N differs across different video frames of the same video that is transmitted from the transmitting device to the recipient device.

6. The method of claim 1, wherein the determining of step (c) is performed dynamically on a Per Video-Packet Basis, and is performed a plurality of times while the recipient device keeps receiving video packets of said particular video frame; wherein for said particular video frame, the transmitting device encodes a total of N video packets as a full representation of said particular video frame; wherein, upon receiving only M1 video packets out of said total of N video packets, the recipient device determines to continue waiting for not-yet-arrived video packets of said particular video frame; and wherein, conversely, upon receiving only M2 video packets of said total of N video packets, wherein M2 is greater than M1 but wherein M2 is smaller than N, the recipient device determines to stop waiting for not-yet-arrived video packets of said particular video frame and determines to immediately decode and render said particular video frame.

7. The method of claim 1, wherein the determining of step (c) is performed dynamically on a Per Video-Frame Portion Basis, and is performed a plurality of times while the recipient device keeps receiving video packets of said particular video frame; wherein for said particular video frame, the transmitting device encodes a total of N video packets as a full representation of said particular video frame; wherein, upon receiving only a first portion P1 of said total of N video packets, the recipient device determines to continue waiting for not-yet-arrived video packets of said particular video frame; and wherein, conversely, upon receiving only a second portion P2 of said total of N video packets, wherein P2 is greater than P1, the recipient device determines to stop waiting for not-yet-arrived video packets of said particular video frame and determines to immediately decode and render said particular video frame.

8. The method of claim 1, wherein the determining of step (c) comprises: if the Communication Network Jitter Level is greater than a pre-defined network jitter value, then performing step (c2) of immediately decoding and rendering; otherwise, performing step (c1) of waiting for arrival of one or more additional packets of said particular video frame.

9. The method of claim 8, wherein, upon performing step (c1) of waiting for arrival of one or more additional packets of said particular video frame, the method further comprises: stopping said waiting, and switching to perform step (c2) of immediately decoding and rendering said particular video frame, if a pre-defined time-period elapsed since arrival of a most-recent packet of said particular video frame.

10. The method of claim 8, wherein step (c) of selectively and dynamically determining, is performed on a per-frame basis and is based exclusively on (i) the number of packets M that already arrived for said particular video frame, and (ii) a value of the Communication Network Jitter Level as estimated by the recipient device.

11. The method of claim 10, wherein step (c) of selectively and dynamically determining, is performed on a per-frame basis and is independent from, and does not rely on, arrival or non-arrival of packets in any video frames that precede said particular video frame.

12. The method of claim 11, wherein step (c) of selectively and dynamically determining, is performed on a per-frame basis and is independent from, and does not rely on, arrival or non-arrival of packets in any video frames that follow said particular video frame.

13. The method of claim 12, wherein the selectively and dynamically determining in step (c) is performed on a per-frame basis and is independent from, and does not rely on, an importance for decoding purposes of a payload that is carried by not-yet-arrived N-M packets of said particular video frame.

14. (canceled)

15. The method of claim 1, wherein the determining of step (d) is performed on a per-frame basis and also on a per-packet basis, and comprises: (I) for said particular video frame, selectively sending from the recipient device a first Retransmission Request to request retransmission of a first particular packet of said particular video frame, and also, (II) for same said particular video frame, selectively skipping to send from the recipient device a second Retransmission Request with regard to a second, different, particular packet of said particular video frame.

16. The method of claim 15, wherein the determining of step (d), on a per-frame basis and also on a per-packet basis, of whether or not to send a Retransmission Request for a particular missing packet of said particular video frame, is based on: an estimation at the recipient device with regard to an importance of said particular missing packet for successful decoding of said particular video frame.

17. The method of 1, further comprising:
(e1) measuring bitrate of video frames that are generated via a Constant Bitrate (CBR) video encoding scheme by a video encoder of the transmitting device;
(e2) determining a highest peak of said bitrate of video frames;
(e3) determining a generally-constant bitrate value of said video frames;
(e4) determining a Peak-to-Average Ratio (PAR) value of said video frames, by dividing said highest peak by said generally-constant bitrate value;
(f) at the transmitting device, dynamically modifying an operational setting of the video encoder of said transmitting device, to reduce said PAR value.

18. The method of claim 17, comprising: iteratively performing step (f) by applying gradual modifications to said operational setting of the video encoder, until convergence towards a target PAR value.

19. The method of claim 17, comprising: iteratively performing step (f) until said PAR value is lower than 2.

20. A system comprising: one or more hardware processors, that are configured to execute code; wherein the one or more hardware processors are operably associated with one or more memory units that are configured to store code; wherein the one or more hardware processors are configured to perform a method of video transmission over an Internet Protocol (IP) communication link, from a transmitting device to a recipient device, wherein the method comprises:
(a) at the recipient device, estimating a Communication Network Jitter Level that dynamically quantifies the degree of jitter in the communication network between the transmitting device and the recipient device, wherein the Communication Network Jitter Level indicates a level of variance in delay of packet arrival at the recipient device from the transmitting device;
(b) at the recipient device, receiving M out of N packets of a particular video frame, wherein N is greater than M, and wherein N packets are packetized and transmitted from the transmitting device as a representation of said particular video frame;
(c) at the recipient device, selectively and dynamically determining, based on the Communication Network Jitter Level, whether (c1) to wait for arrival of one or more packets of not-yet-arrived N-M packets of said particular video frame while not yet decoding and rendering said particular video frame, or conversely, (c2) to not wait for arrival of additional packets of said particular video frame and to immediately perform decoding and rendering of said particular video frame; and
(d) at the recipient device, selectively and dynamically determining, on a per-frame basis, and by taking into account the Communication Network Jitter Level, whether (d1) to send from the recipient device to the transmitting device a Retransmission Request for a missing packet of said particular video frame, or conversely, (d2) to skip sending from the recipient device to the transmitting device a Retransmission Request for said missing packet of said particular video frame.
